(19) United States
(12) Patent Application Publication
(10) Pub. No.: US 2026/0292918 A1
(43) Pub. Date: Sep. 24, 2026

(54) USER EQUIPMENT BEHAVIOR FOR PLMN AND RAT SELECTION DURING SUSPENDED NAS SIGNALING

(71) Applicant: MEDIATEK SINGAPORE PTE. LTD., Singapore (SG)

(72) Inventors: Puneet ., Bengaluru (IN); Marko NIEMI, Oulu (FI)

(73) Assignee: MEDIATEK SINGAPORE PTE. LTD., Singapore (SG)

(21) Appl. No.: 19/474,483

(22) PCT Filed: Jun. 11, 2024
(86) PCT No.: PCT/CN2024/098339

§ 371 Date: Oct. 10, 2025

(30) Foreign Application Priority Data
Jul. 7, 2023 (IN) 202321045845

(51) Int. Cl. H04W 76/20; H04W 48/18; H04W 88/06

(52) U.S. Cl. CPC H04W 76/20; H04W 48/18; H04W 88/06

(57) ABSTRACT

Techniques pertaining to user equipment (UE) behavior for public land mobile network (PLMN) and radio access technology (RAT) selection during suspended non-access stratum (NAS) signaling in mobile communications are described. An apparatus (e.g., a UE) enters an Evolved Packet System (EPS) Mobility Management idle (EMM-IDLE) mode with suspend indication or a 5th Generation Mobility Management idle (5GMM-IDLE) mode with suspend indication. While in the EMM-IDLE mode with suspend indication or the 5GMM-IDLE mode with suspend indication, the UE behaves in a same way as in an EMM-IDLE mode or a 5GMM-IDLE over a 3rd Generation Partnership Project (3GPP) access.

### CROSS REFERENCE TO RELATED PATENT APPLICATION(S)

The present disclosure claims the priority benefit of Indian Patent Application No. 202321045845, filed 7 Jul. 2023, respectively, the content of which herein being incorporated by reference in its entirety.

### TECHNICAL FIELD

The present disclosure is generally related to mobile communications and, more particularly, to user equipment (UE) behavior for public land mobile network (PLMN) and radio access technology (RAT) selection during suspended non-access stratum (NAS) signaling in mobile communications.

### BACKGROUND

In wireless communications such as mobile communications under the current 3^{rd} Generation Partnership Project (3GPP) specification, suspension of NAS signaling connection can be initiated by a network in an Evolved Packet System (EPS) Mobility Management connected (EMM-CONNECTED) or 5^{th} Generation Mobility Management connected (5GMM-CONNECTED) mode when user plane Cellular Internet of Things (CIoT) EPS optimization is used. Resumption of the suspended NAS signaling connection may be initiated by a UE. Upon indication from lower layers that a radio resource control (RRC) connection has been suspended, the UE is to enter an EMM idle (EMM-IDLE) mode with suspend indication or 5GMM idle (5GMM-IDLE) mode with suspend indication. The UE is to not consider the NAS signaling connection released, and the UE is to not consider a secure exchange of NAS messages terminated.

According to the 3GPP specification, the UE can perform a PLMN selection procedure, and an N1/S1 capability update procedure can be performed in the EMM-IDLE mode and 5GMM-IDLE mode. If the UE is in the EMM-CONNECTED mode or 5GMM-CONNECTED mode, the UE would release the connection locally. If the UE has either persistent protocol data unit (PDU) session or persistent EPS bearer context, the UE is to wait until the radio bearer associated with the persistent EPS bearer context or the persistent PDU session has been released. When the UE is in the EMM-IDLE mode with suspend indication or the 5GMM-IDLE mode with suspend indication, the UE and network would be considered as NAS signaling not released. However, the UE behavior is not defined as to whether or not the PLMN selection procedure or N1/S1 capability update procedure is allowed in the EMM-IDLE mode with suspend indication or the 5GMM-IDLE mode with suspend indication. Moreover, the UE behavior is also not defined as to how the PLMN selection procedure or N1/S1 capability update procedure can be performed in the EMM-IDLE mode with suspend indication or the 5GMM-IDLE mode with suspend indication. Therefore, there is a need for solutions of UE behavior for PLMN and RAT selection during suspended NAS signaling in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to UE behavior for PLMN and RAT selection during suspended NAS signaling in mobile communications. It is believed that implementations of one or more of the schemes proposed herein may address or otherwise alleviate the issues described above. For instance, under the proposed schemes, when in an EMM-IDLE mode with suspend indication or an 5GMM-IDLE mode with suspend indication, a UE may behave the same as in an idle mode.

In one aspect, a method may involve a UE entering an EMM-IDLE mode with suspend indication or a 5GMM-IDLE mode with suspend indication. The method may also involve the UE behaving in a same way as in an EMM-IDLE mode or a 5GMM-IDLE over a 3GPP access while in the EMM-IDLE mode with suspend indication or the 5GMM-IDLE mode with suspend indication.

In another aspect, an apparatus may include a transceiver configured to communicate wirelessly and a processor coupled to the transceiver. The processor may enter an EMM-IDLE mode with suspend indication or a 5GMM-IDLE mode with suspend indication. The processor may also behave in a same way as in an EMM-IDLE mode or a 5GMM-IDLE over a 3GPP access while in the EMM-IDLE mode with suspend indication or the 5GMM-IDLE mode with suspend indication.

It is noteworthy that, although the description provided herein may be in the context of certain radio access technologies, networks, and network topologies such as 5^{th} Generation (5G)/New Radio (NR)/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4^{th} Generation (4G)/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of a second example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UE behavior for PLMN and RAT selection during suspended NAS signaling in mobile communications. According to the present disclosure, a number of possible solutions may be implemented separately or jointly. That is, although these possible solutions may be described below separately, two or more of these possible solutions may be implemented in one combination or another.

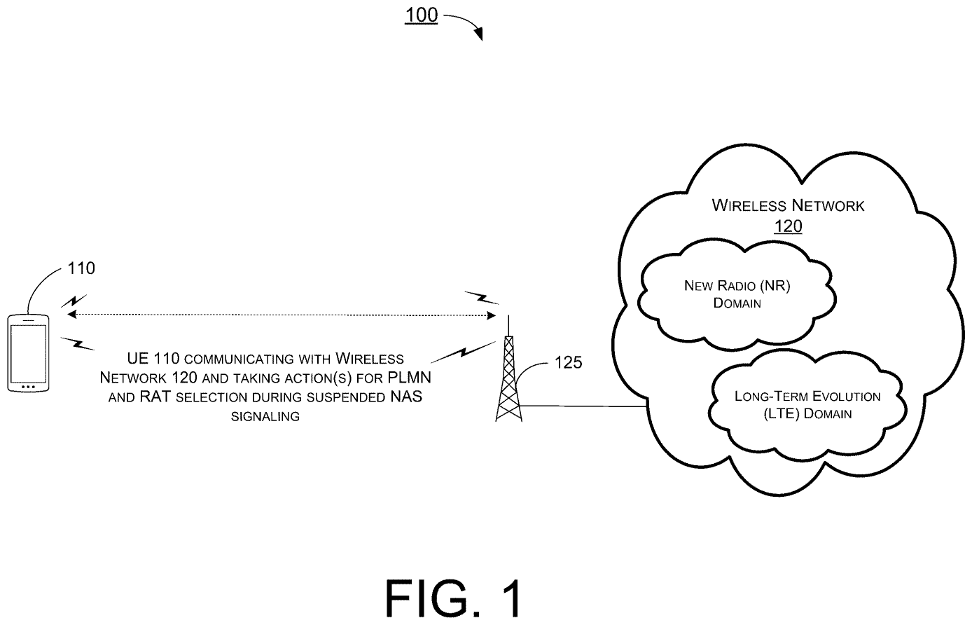

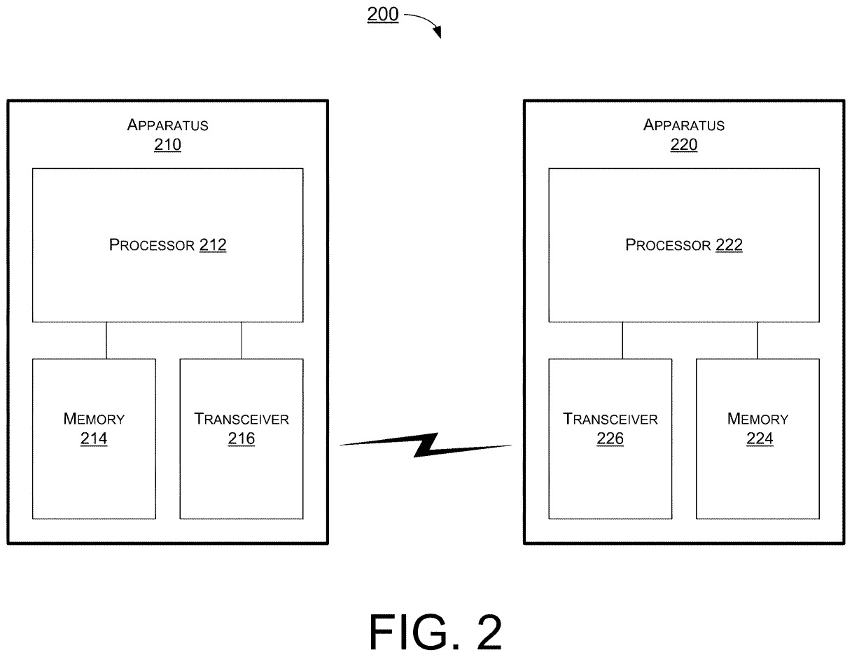

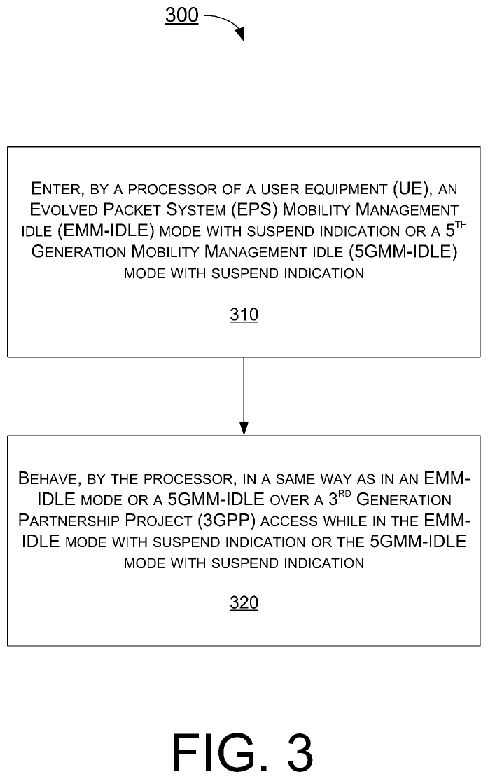

FIG. 1 illustrates an example network environment 100 in which various solutions and schemes in accordance with the present disclosure may be implemented. FIG. 2~FIG. 3 illustrate examples of implementation of various proposed schemes in network environment 100 in accordance with the present disclosure. The following description of various proposed schemes is provided with reference to FIG. 1~FIG. 3.

Referring to FIG. 1, network environment 100 may involve a UE 110, such as a mobile device or smartphone, in wireless communication with a wireless network 120 as part of a communication network. The wireless network 120 may be a public land mobile network (PLMN) including 5G/NR domain and 4G/LTE domain. UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to UE behavior for PLMN and RAT selection during suspended NAS signaling in mobile communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

Under a first proposed scheme in accordance with the present disclosure, when UE 110 is in an EMM-IDLE mode with suspend indication or in a 5GMM-IDLE mode with suspend indication, UE 110 may perform a PLMN selection procedure.

Under a second proposed scheme in accordance with the present disclosure, when UE 110 is in an EMM-IDLE mode with suspend indication or in a 5GMM-IDLE mode with suspend indication, UE 110 may perform an N1/S1 capability updated procedure.

Under a third proposed scheme in accordance with the present disclosure, when UE 110 is in an EMM-IDLE mode with suspend indication or in a 5GMM-IDLE mode with suspend indication, NAS may indicate to a lower layer to abort RRC connection suspension locally and enter the EMM-IDLE mode without suspend indication or the 5GMM-IDLE mode without suspend indication.

Under a fourth proposed scheme in accordance with the present disclosure, when UE 110 is in an EMM-IDLE mode with suspend indication or in a 5GMM-IDLE mode with suspend indication, the NAS may indicate to the lower layer to resume RRC connection and enter the EMM-CONNECTED mode or 5GMM-CONNECTED mode. Moreover, UE 110 may locally release an established NAS signaling connection and enter the EMM-IDLE mode without suspend indication or the 5GMM-IDLE mode without suspend indication.

Under a fifth proposed scheme in accordance with the present disclosure, when UE 110 is in a 5GMM-IDLE mode with suspend indication, UE 110 may behave in a same way as in a 5GMM-IDLE mode over the 3GPP access. For instance, UE 110 may perform a PLMN selection procedure and/or an N1/S1 capability updated procedure in the 5GMM-IDLE mode with suspend indication in a same way as in the 5GMM-IDLE mode over a 3GPP access.

Under a sixth proposed scheme in accordance with the present disclosure, when UE 110 is in an EMM-IDLE mode with suspend indication, UE 110 may behave in a same way as in an EMM-IDLE mode over the 3GPP access. For instance, UE 110 may perform a PLMN selection procedure and/or an N1/S1 capability updated procedure in the EMM-IDLE mode with suspend indication in a same way as in the EMM-IDLE mode over the 3GPP access.

It is noteworthy that, although the various proposed schemes are individually described above, in actual implementations, two or more of the proposed schemes may be implemented or executed jointly (e.g., sequentially or in parallel).

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to UE behavior for PLMN and RAT selection during suspended NAS signaling in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to UE behavior for PLMN and RAT selection during suspended NAS signaling in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example process 300.

### Illustrative Processes

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to UE behavior for PLMN and RAT selection during suspended NAS signaling in mobile communications in accordance with the present disclosure. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210 entering an EMM-IDLE mode with suspend indication or a 5GMM-IDLE mode with suspend indication. Process 300 may proceed from 310 to 320.

At 320, process 300 may involve processor 212 behaving in a same way as in an EMM-IDLE mode or a 5GMM-IDLE over a 3GPP access while in the EMM-IDLE mode with suspend indication or the 5GMM-IDLE mode with suspend indication.

In some implementations, in behaving, process 300 may involve processor 212 performing a procedure as in the EMM-IDLE mode or the 5GMM-IDLE mode over the 3GPP access.

In some implementations, in performing the procedure, process 300 may involve processor 212 performing a PLMN selection procedure. Alternatively, or additionally, in performing the procedure, process 300 may involve processor 212 performing an N1 or S1 capability updated procedure.

In some implementations, in entering the EMM-IDLE mode with suspend indication or the 5GMM-IDLE mode with suspend indication, process 300 may involve processor 212 entering the EMM-IDLE mode with suspend indication or the 5GMM-IDLE mode with suspend indication responsive to a network suspending a NAS signaling connection in an EMM-CONNECTED or 5GMM-CONNECTED mode.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
entering, by a processor of a user equipment (UE), an Evolved Packet System (EPS) Mobility Management idle (EMM-IDLE) mode with suspend indication or a 5^{th} Generation Mobility Management idle (5GMM-IDLE) mode with suspend indication; and
behaving, by the processor, in a same way as in an EMM-IDLE mode or a 5GMM-IDLE over a 3^{rd} Generation Partnership Project (3GPP) access while in the EMM-IDLE mode with suspend indication or the 5GMM-IDLE mode with suspend indication.

2. The method of claim 1, wherein the behaving comprises performing a procedure as in the EMM-IDLE mode or the 5GMM-IDLE mode over the 3GPP access.

3. The method of claim 2, wherein the performing of the procedure comprises performing a public land mobile network (PLMN) selection procedure.

4. The method of claim 2, wherein the performing of the procedure comprises performing an NI or SI capability updated procedure.

5. The method of claim 1, wherein the entering of the EMM-IDLE mode with suspend indication or the 5GMM-IDLE mode with suspend indication comprises entering the EMM-IDLE mode with suspend indication or the 5GMM-IDLE mode with suspend indication responsive to a network suspending a non-access stratum (NAS) signaling connection in an EMM connected (EMM-CONNECTED) or 5GMM connected (5GMM-CONNECTED) mode.

6. An apparatus implementable in a user equipment (UE), comprising:
a transceiver configured to communicate wirelessly; and
a processor coupled to the transceiver and configured to perform operations comprising:
entering an Evolved Packet System (EPS) Mobility Management idle (EMM-IDLE) mode with suspend indication or a 5^{th} Generation Mobility Management idle (5GMM-IDLE) mode with suspend indication; and
behaving in a same way as in an EMM-IDLE mode or a 5GMM-IDLE over a 3^{rd} Generation Partnership Project (3GPP) access while in the EMM-IDLE mode with suspend indication or the 5GMM-IDLE mode with suspend indication.

7. The apparatus of claim 6, wherein the behaving comprises performing, via the transceiver, a procedure as in the EMM-IDLE mode or the 5GMM-IDLE mode over the 3GPP access.

8. The apparatus of claim 7, wherein the performing of the procedure comprises performing a public land mobile network (PLMN) selection procedure.

9. The apparatus of claim 7, wherein the performing of the procedure comprises performing an N1 or S1 capability updated procedure.

10. The apparatus of claim 6, wherein the entering of the EMM-IDLE mode with suspend indication or the 5GMM-IDLE mode with suspend indication comprises entering the EMM-IDLE mode with suspend indication or the 5GMM-IDLE mode with suspend indication responsive to a network suspending a non-access stratum (NAS) signaling connection in an EMM connected (EMM-CONNECTED) or 5GMM connected (5GMM-CONNECTED) mode.
